(19) United States
(12) Patent Application Publication
(10) Pub. No.: US 2014/0101882 A1
(43) Pub. Date: Apr. 17, 2014

(54) REAR WINDSHIELD WIPER ARM ASSEMBLY WITH SERVICE UP DETENT POSITION

(71) Applicant: TRICO PRODUCTS CORPORATION, Rochester Hills, MI (US)

(72) Inventor: C. Joseph Thielen, Shelby Twp., MI (US)

(73) Assignee: TRICO PRODUCTS CORPORATION, Rochester Hills, MI (US)

(21) Appl. No.: 13/651,574

(22) Filed: Oct. 15, 2012

(51) Int. Cl. B60S 1/06

(52) U.S. Cl. 15/250.31

(57) ABSTRACT

A rear windshield wiper arm assembly is adapted to support a wiper assembly as it moves across a surface to be wiped. The wiper arm assembly includes a head adapted to be mounted to a pivot shaft that defines a pivot axis and drives the wiper assembly in an oscillating manner across the surface to be wiped and a wiper arm supported on the head and rotatable thereto. The head has at least one boss and the wiper arm has at least one boss cooperating with the at least one boss on the head when the wiper arm is rotated relative to the head to form a service up detent position for the wiper arm.

### BACKGROUND OF THE INVENTION

1. Field of the Invention

The present invention relates generally to wiper arm assemblies and, more specifically, to a wiper arm assembly for a rear windshield that is adapted to support a wiper assembly as it moves across a surface to be wiped and having a service up decent position.

2. Description of the Related Art

Conventional windshield wiper systems known in the related art include some type of wiper assembly mounted to a wiper arm assembly which, in turn, is mounted adjacent to a surface to be wiped, such as a windshield. The wiper arm assembly includes a wiper arm that is pivotally driven to impart reciprocal motion to the wiper assembly across the windshield. The wiper assembly includes a rubber wiping element that contacts the windshield across the surface to be wiped. The wiping element is commonly either of the “tournament” or “beam blade” type. Both types of wiper assemblies commonly known in the related art typically incorporate one or more metal strips that act to reinforce the wiping element and facilitate wiping contact by the wiping element across what is typically a curved glass surface. In this context, the wiper arm assembly delivers a downward force to the wiper assembly that is distributed thereacross, pressing the wiping element into contact with the surface to be wiped.

Typically, the wiper arm assembly requires a method of positioning the wiper arm in a raised service up position whereby a vehicle operator is able to service the wiper assembly. Vehicle operators commonly also raise wiper arms to the service up position when they clean the glass and/or to remove snow/ice from the windshield. The ability of a wiper arm to be positioned in a service up orientation is also commonly used during inclement weather conditions in which the vehicle is parked and heavy snowfall is imminent. This eases snow/ice removal from the windshield and prevents the wiping element from freezing to the glass of the windshield.

Virtually all wiper systems used on front vehicle applications are designed such to allow the wiper arm to be raised into a service up position. The service up position is achieved when an arm retainer passes above a toggle point in which a spring force retains the wiper arm in the service up position, typically above a 50 degree arc.

Wiper systems used on rear vehicle applications are typically no longer designed to raise the wiper arm into a service up position. Those that do are more susceptible to being caught in automated carwash equipment. In order to avoid this type of damage, and to minimise warranty costs to wiper manufacturers, rear wiper arms generally do not have a service up position. Rear wiping elements can still be serviced and the rear glass can still be cleaned, hut it requires the vehicle operator to lift and hold the rear wiper arm in a raised position with one hand, while performing the wiping element replacement, or cleaning, with the other hand. Rear wiper arms with non-service up capabilities also cannot be raised to a toggled service up position where they may remain up during inclement weather. This causes rear wiping elements to become frozen to the rear glass of the rear windshield during periods of heavy snow.

Thus, there remains a need in the art for a wiper arm assembly for a rear windshield that employs a service up detent position, but which minimizes carwash damage and keeps the wiping element up off the glass of the rear windshield during servicing.

### SUMMARY OF THE INVENTION

The present invention overcomes many limitations and disadvantages in the related art in a wiper arm assembly for a rear windshield adapted to support a wiper assembly as it moves across a surface of the rear windshield to be wiped. The wiper arm assembly includes a head adapted to be mounted to a pivot shaft that defines a pivot axis and drives the wiper assembly in an oscillating manner across the surface and a wiper arm supported on the head and rotatable thereto. The head has at least one boss and the wiper arm has at least one boss cooperating with the at least one boss on the head when the wiper arm is rotated relative to the head to form a service up detent position for the wiper arm.

In this way, the wiper arm assembly of the present invention employs a service up detent position for the wiper arm that functions just like typical arms do while used to wipe the glass of the rear windshield. However, when the wiper arm is raised off the glass to its maximum position, a boss on the head encounters a boss on the wiper arm that slightly moves the head rearward in a trunnion groove, against spring resistance, into a detent position. The wiper arm remains in this raised position by virtue of the spring force that maintains contact between the boss on the head and the boss on the wiper arm. The vehicle operator is then free to service the wiping element, clean the glass of the rear windshield, or leave the wiper arm in this raised position to prevent snow or ice from freezing the wiping element to the glass of the rear windshield.

Other objects, features, and advantages of the present invention will be readily appreciated as the same becomes better understood after reading the subsequent description taken In connection with the accompanying drawings.

### BRIEF DESCRIPTION OF THE DRAWINGS

FIG. 1 is a partial perspective view of a representation of a rear of a vehicle illustrating a wiper system having a wiper arm assembly, according to one embodiment of the present invention;

FIG. 2 is a perspective exploded fragmentary view of a wiper arm assembly, according to one embodiment of the present invention; of the wiper system of FIG. 1;

FIG. 3 is a cross-sectional side view of the wiper arm assembly, according to one embodiment of the present invention, of FIG. 2 illustrating a service up position; and

FIG. 4 is a cross-sectional side view of the wiper assembly, according to one embodiment of the present inventions of FIG. 2 illustrating a wiping position.

### DESCRIPTION OF THE PREFERRED EMBODIMENT(S)

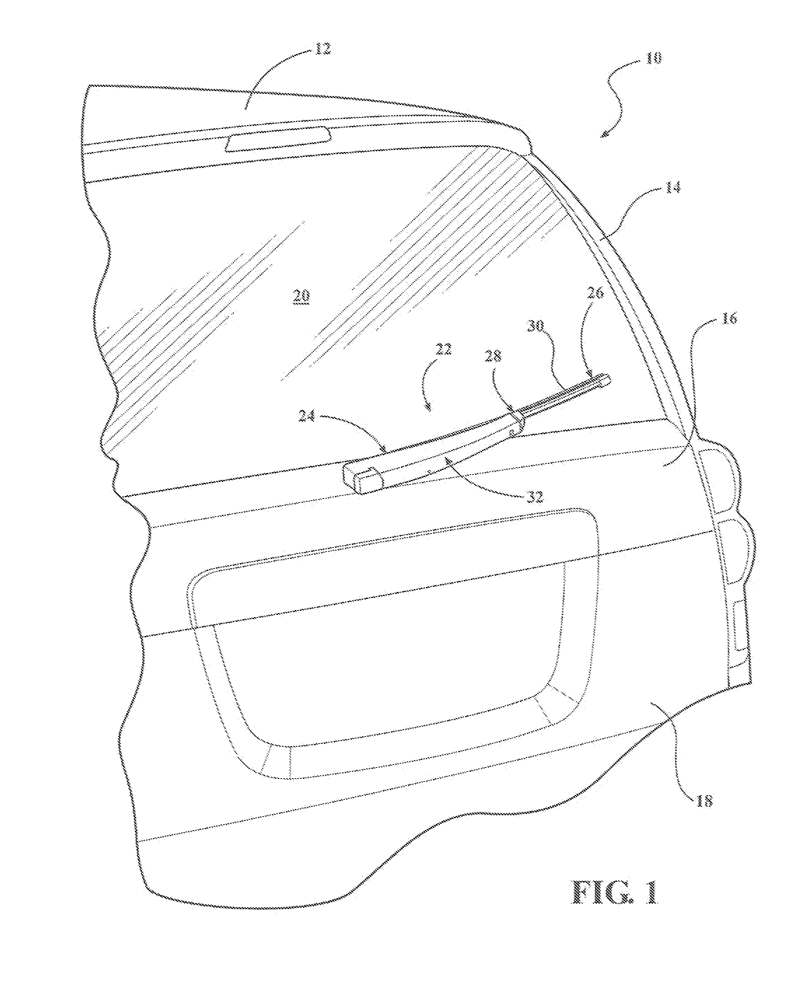

Referring now to the figures, where like numerals are used to designate like structure, a portion of a vehicle 10 is schematically illustrated in FIG. 1. More specifically, the portion of the vehicle 10 that has been employed to illustrate the present invention includes a generic illustration of a rear of a vehicle. Thus, the vehicle 10 includes a roof 12, a pair of pillars 14 (only one of which is shown in FIG. 1), a lift gate 16, and a rear portion 18 of the vehicle 10. The vehicle 10 also includes a glass rear window or windshield 20 extending between the pillars 14 on the lift gate 16. While the rear portion 18 of the vehicle 10 illustrated herein employs a lift gate 16, those having ordinary skill in the art will appreciate from the description that follows that the vehicle 10 could include a hatch back or any other commonly known configuration without departing from the scope of the present invention.

The vehicle 10 further includes a wiper system, generally shown at 22 in FIG. 1 and in the embodiment illustrated here, employed to clean or wipe the glass rear window 20. The wiper system 22 includes a wiper arm assembly, generally indicated at 24, and a wiper assembly, generally indicated at 26. In the embodiment illustrated herein, the wiper arm assembly 24 is operatively mounted to the lift gate 16 and is moveable in an oscillating fashion to move the wiper assembly 26 across the rear window 20. The wiper assembly 26 is releasably engaged to the wiper arm assembly 24 via a coupler assembly, generally indicated at 28, that operatively interconnects the wiper assembly 26 and wiper arm assembly 24. The wiper assembly 26 is adapted to clean the surface to be wiped, in this case, the rear window 20. Those having ordinary skill in the art will appreciate that the wiper system 22 may include other components besides the wiper arm assembly 24 and wiper assembly 26.

The wiper assembly 26 has a wiping element 30 that includes a predetermined length and cross-sectional profile corresponding to a particular application and is typically manufactured through an extrusion process, which enables the length and cross-sectional profile of the wiping element 30 to be easily adjusted without a substantial increase to manufacturing expense. Furthermore, while the wiping element 30 is constructed from a flexible rubber. Those having ordinary skill in the art will appreciate that the wiping element 30 may be constructed from any flexible material, such as silicone or other polymer, and via any manufacturing process, such as injecting molding, without departing from the scope of the present invention.

Those having ordinary skill in the art will also appreciate that the wiper assembly 26 may be of either the tournament or beam blade type having any standard construction as is commonly known in the art. Thus, whether the wiper assembly is a tournament or beam style blade, it will generally distribute downward pressure from the wiper arm assembly 24 across the wiping element 30. Moreover, the wiper assembly 26 may be curved longitudinally with a predetermined radius of curvature that is the same or less than the plane of curvature of the rear window 20, if any. This predetermined radius of curvature is sometimes referred to in the related art as a “free form” radius of curvature (hereinafter “windshield curvature”). Accordingly, the curvature of the wiper assembly 26 may be symmetrical or asymmetrical depending on the force requirements and the contour of the surface to be wiped. The flexible, free form, pre-curved wiper assembly 26 straightens out when the wiper arm assembly 24 applies a force thereto to flatten it and direct the wiping element 30 to contact the surface to be wiped. Thus, the wiper assembly 26 may include a free-form curvature that ensures force distribution on rear windows 20 or windshields having various curvatures that effects proper wrapping about the surface to be wiped. The wiper assembly 26 may also include an airfoil to reduce the likelihood of wind lift during operational movement across the surface to be wiped. However, those having ordinary skill in the art will appreciate that the airfoil is optional, especially where the wiper assembly 26 is employed on a rear window 20.

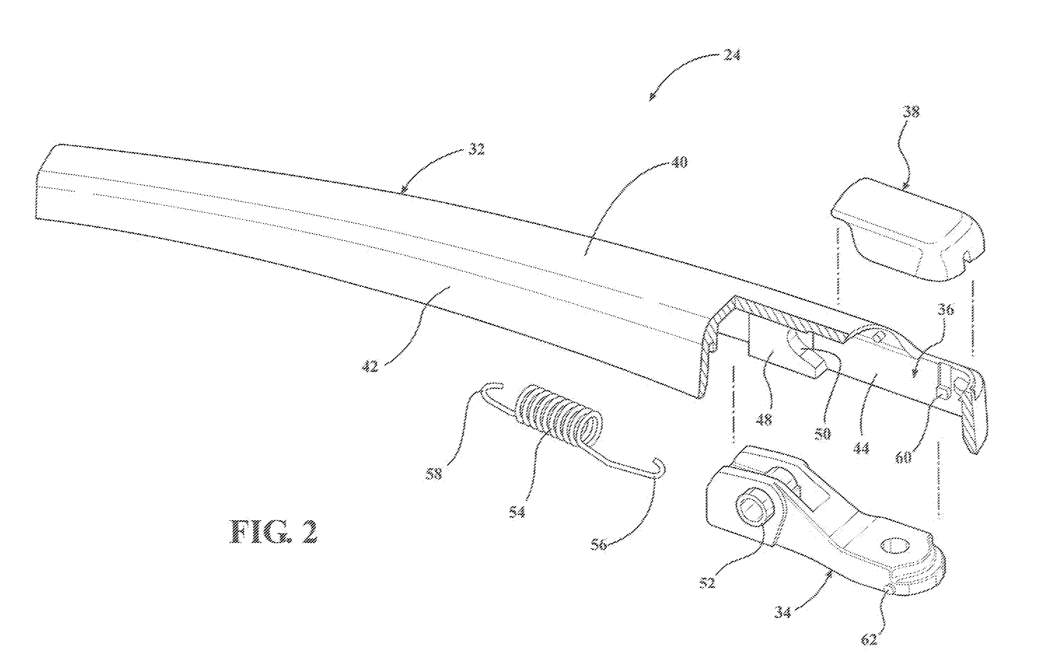

Referring to FIG. 2, the wiper arm assembly 24 is operatively mounted to a pivot shaft (not shown), which, in turn, is driven by an electrical motor (not shown) either directly or through appropriate linkages (not shown) as is commonly known in the art. To this end, the wiper arm assembly 24 includes an elongated body or wiper arm, generally indicated at 32, and a head, generally indicated at 34, that supports the wiper arm 32 and adapted to be mounted to the pivot shaft that defines a pivot axis and drives the wiper assembly 26 in an oscillating manner across the surface to be wiped. The head 34 is operatively mounted to the pivot shaft via a nut (not shown) threaded onto the distal end of the pivot shaft or via any suitable fastener known in the related art. in addition, the wiper arm 32 includes an opening 36 that provides access to the head 34 mounted to the pivot shaft. The wiper arm assembly 24 includes a cover, generally indicated at 38, mounted to the wiper arm 32 at the opening 36 and is movable from a first position closing the opening 36 to a second position opening the opening 36 and allowing access to the head 34. Each of these components of the wiper arm assembly 24 will be described in greater detail below.

Referring to FIGS. 2-4, the wiper arm 32 has a top wall 40 and side walls 42 depending from the top wall 40 so as to define an inversely open ended U-shape with an interior cavity 44. The head 34 is disposed in the interior cavity 44 of the wiper arm 32. To this end, the wiper arm 32 includes a pair of flanges 48 opposite one another and that present a pair of inwardly facing elongated openings or trunnion grooves 50. The head 34 may employ a pair of bearings or trunnions 52 that are cooperatively received in the trunnion grooves 50 such that the wiper arm 32 may pivot relative to the head 34 about an axis defined by the trunnions 52.

The wiper arm assembly 24 also includes a biasing member 54, such as a coiled spring, disposed in the interior cavity 44 and operatively connected between the head 34 and the body 32, as is commonly known, in the art. The biasing member 54 has a first end 56 connected to a projection 46 on the head 34 and a second end 58 connected to a flange (not shown) of the body 32. The biasing member 54 generates a downward force on the wiper assembly 26 as it oscillates across the surface to be wiped.

The trunnion grooves 50 open in a direction that is below an imaginary horizontal line extending through the center of the trunnions 52. The trunnion grooves 50 essentially capture the head 34 during assembly under the force provided by the biasing member 54. At the same time, this interaction allows rotation of the wiper arm 32 relative to the head 34. Thus, the biasing member 54 retains the wiper arm 32 relative to the head 34 during use without the need of a rivet. The top wall 40 and sidewalls 42 of the wiper arm 32 essentially envelopes the arm/head joint from both sides as well as from the top. This arrangement offers protection from snow and ice buildup that commonly causes conventional arms to freeze during wintery weather conditions causing loss of arm load resulting in poor wipe quality. In addition, the operative interaction between the head 34 and wiper arm 32 requires no tools or fastening mechanisms and all components can be assembled by hand. Thus, the operation of the wiper arm 32 relative to the head 34 effectively lowers the cost of the joint formed therebetween.

The wiper arm 32 also has at least one boss 60 extending inwardly from one of the side walls 42 and into the interior cavity 44. The head 34 also has at least one boss 62 extending outwardly for cooperation with the boss 60. The boss 60 is generally rectangular in shape and has two arcuate surfaces 64 on one side. The boss 62 is generally rectangular in shape and has two opposed arcuate surfaces 64. The bosses 60 and 62 cooperate with each other to form a service up detent position for the wiper arm 32.

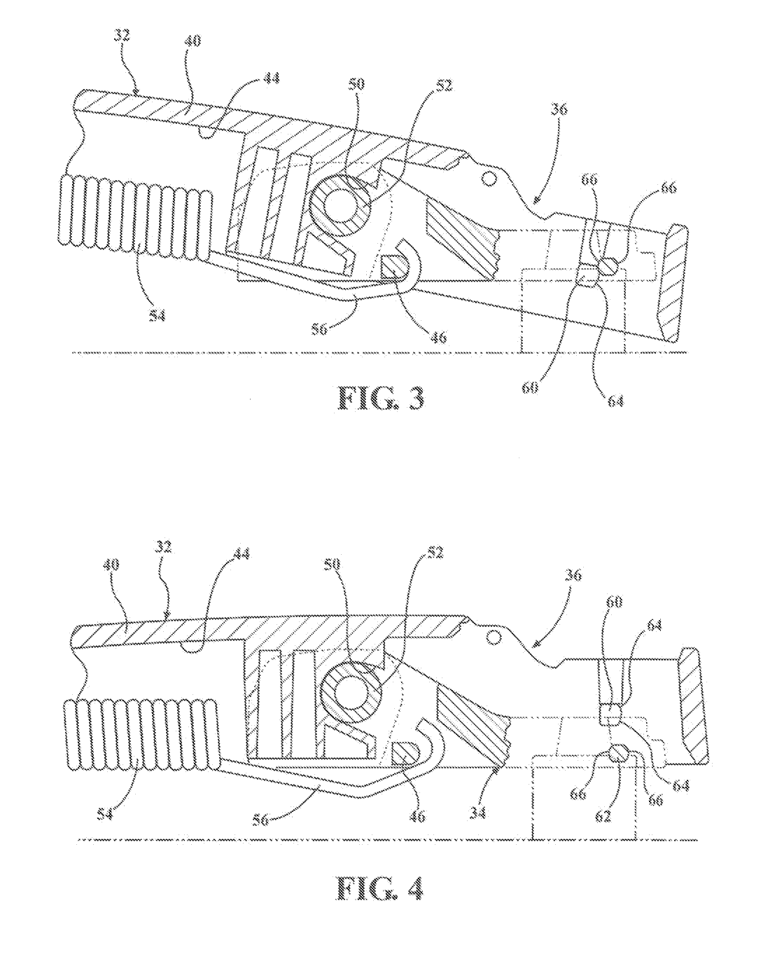

In operation of the wiper arm assembly 24, the wiper arm 32 is raised off the rear window 20 by rotating the wiper arm 32 relative to the head 34. When the wiper arm 32 is raised to its maximum position, the wiper arm 32 slides forward slightly, via the trunnion grooves 50, as the boss 60 on the wiper arm 32 passes over the boss 62 on the head 34 against resistance of the spring 54, into a service up detent position as illustrated in FIG. 3. The wiper arm 32 remains in this raised position by virtue of the force from the spring 54 that maintains contact between the boss 62 on the head 34 and the boss 60 on the wiper arm 32. The vehicle operator is then free to service the wiper assembly 26, clean the glass rear window 20, or leave the wiper arm 32 in this raised position to prevent snow or ice from freezing the wiping clement 30 to the glass rear window 20.

To lower the wiper arm 32 to its normal park or wiping position as illustrated in FIG. 4, the wiper arm 32 is rotated relative to the head 34. As this occurs, the wiper arm 32 slides rearward slightly, via the trunnion grooves 50, as the boss 60 on the wiper arm 32 passes by the boss 62 on the head 34 and the trunnions 52 return forward in the trunnion grooves 50 against the resistance of the spring 54. The wiper arm assembly 24 is then free to move the wiper assembly 26 across the rear window 20. It should be appreciated that the arcuate surfaces 64 and 66 allow smooth contact between the bosses 60 and 62, respectively.

The present invention has been described in an illustrative manner. It is to be understood that the terminology which has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A wiper arm assembly for a rear windshield adapted to support a wiper assembly as it moves across a surface of the rear windshield to be wiped, said wiper arm assembly comprising:
a head adapted to be mounted to a pivot shaft that defines a pivot axis and drives the wiper assembly in an oscillating manner across the surface;
a wiper arm supported on said head and rotatable thereto; and
said head having at least one boss and said wiper arm having at least one boss cooperating with said at least one boss on said head when said wiper arm is rotated relative to said head to form a service up detent position for said wiper arm.

2. A wiper arm assembly as set forth in claim 1 wherein said head includes a pair of opposed trunnions extending outwardly.

3. A wiper arm assembly as set forth in claim 2 wherein said wiper arm has a pair of opposed trunnion openings to receive said trunnions.

4. A wiper arm assembly as set forth in claim 3 wherein said trunnion openings are elongated.

5. A wiper arm assembly as set forth in claim 3 including a spring interconnecting said wiper arm and said head to bias said trunnions into said trunnion openings and adapted to generate a downward force on the wiper assembly as it oscillates across the surface.

6. A wiper arm assembly as set forth in claim 5 wherein said wiper arm includes a top wall and side walls depending from said top wall so as to define an inversely open ended U-shape with an interior cavity,

7. A wiper arm assembly as set forth in claim 6 wherein said wiper arm has a pair of opposed flanges extending from said top wall and into said interior cavity, each of said flanges having one of said trunnion grooves.

8. A wiper arm assembly as set forth in claim 1 wherein said at least one boss on said wiper arm extends inwardly from one of said side walls and into said interior cavity.

9. A wiper arm assembly as set forth in claim 8 wherein said head is disposed inside said interior cavity of said wiper arm.

10. A wiper arm assembly adapted to support a wiper assembly as it moves across a surface of a rear window to be wiped, said wiper arm assembly comprising:
a head adapted to be mounted to a pivot shaft that defines a pivot axis and drives the wiper assembly in an oscillating manner across the surface, said head including a pair of opposed trunnions extending outwardly and at least one boss extending outwardly;
a wiper arm supported on said head and rotatable thereto, said wiper arm including a top wall and side walls depending from said top wall so as to define an inversely open ended U-shape with an interior cavity, a pair of opposed flanges extending from said top wall and into said interior cavity, each of said flanges having one of a pair of opposed and elongated trunnion openings to receive said trunnions;
a spring interconnecting said wiper arm and said head to bias said trunnions into said trunnion openings and adapted to generate a downward force on the wiper assembly as it oscillates across the surface to be wiped; and
said wiper arm having at least one boss extending inwardly from one of said side walls and into said interior cavity and cooperating with said at least one boss on said head when said wiper arm is rotated relative to said head to form a service up detent position for said wiper arm.

11. A rear wiper system for a vehicle comprising;
a wiper assembly adapted to contact a surface to be wiped;
a wiper arm assembly adapted to support said wiper assembly as it moves across the surface to be wiped;
said wiper arm assembly including a head adapted to be mounted to a pivot shaft that defines a pivot axis and drives said wiper assembly in an oscillating manner across the surface to be wiped, a wiper arm supported by said head and rotatable thereto, said head having at least one boss and said wiper arm having at least one boss cooperating with said at least one boss on said head when said wiper arm is rotated relative to said head to form a service up detent position for said wiper arm.

12. A rear wiper arm assembly as set forth in claim 11 wherein said head includes a pair of opposed trunnions extending outwardly.

13. A rear wiper arm assembly as set forth in claim 12 wherein said wiper arm has a pair of opposed trunnion openings to receive said trunnions.

14. A rear wiper arm assembly as set forth in claim 13 wherein said trunnion openings are elongated.

15. A rear wiper arm assembly as set forth in claim 13 including a spring interconnecting said wiper arm and said head to bias said trunnions into said trunnion openings and adapted to generate a downward force on said wiper assembly as it oscillates across the surface to be wiped.

16. A rear wiper arm assembly as set forth in claim 15 wherein said wiper arm includes a top wall and side walls depending from said top wall so as to define an inversely open ended U-shape with an interior cavity.

17. A rear wiper arm assembly as set forth in claim 16 wherein said wiper arm has a pair of opposed flanges extending from said top wall and into said interior cavity, each of said flanges having one of said trunnion grooves.

18. A rear wiper arm assembly as set forth in claim 16 wherein said at least one boss on said body extends inwardly from one of said side walls and into said interior cavity.
